(19) United States
(12) Patent Application Publication
(10) Pub. No.: US 2010/0103086 A1
(43) Pub. Date: Apr. 29, 2010

(54) Liquid crystal display panel for performing polarity inversion therein

(75) Inventors: Shuo-Ting Yan, Miao-Li (TW); Chih-Hao Chen, Miao-Li (TW); Wen Hsiung Liu, Miao-Li (TW); Eddy Giing-Lii Chen, Miao-Li (TW); Tsau-Hua Hsieh, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 12/589,602

(22) Filed: Oct. 26, 2009

(30) Foreign Application Priority Data
Oct. 24, 2008 (CN) 200810216917.X

(51) Int. Cl. G09G 3/36

(52) U.S. Cl. 345/92; 345/87

(57) ABSTRACT

A liquid crystal display panel includes a display area. The display area includes a first scanning line, two second scanning lines, and a number of pixel units arranged in two rows and a number of columns. The number of columns include a number of first columns and a number of second columns arranged alternately. The pixel units arranged in the number of first columns are controlled via the first scanning line, and the two pixel units arranged in each of the number of second columns are controlled via the two second scanning lines correspondingly.

### BACKGROUND

1. Technical Field

The present disclosure relates to displays, and more particularly to a liquid crystal display (LCD) panel.

2. Description of Related Art

LCD panels are widely used in electronic devices. Referring to FIG. 5, one such LCD panel 10 includes M scanning lines 110, N data lines 120, a plurality of pixel units 130 arranged in a matrix, a scanning driving circuit 140 providing scanning signals sequentially to the M scanning lines 110, a data driving circuit 150 providing data signals to the N data lines 120, and a common voltage generating circuit 160. Each pixel unit 130 is defined by two adjacent data lines 120 crossing two adjacent scanning lines 110.

Each of the plurality of pixel units 130 includes a thin film transistor (TFT) 131 and a capacitor 132. Two ends of the capacitor 132 of each of the plurality of pixel units 130 represent a pixel electrode 133 and a common electrode 134 respectively. The pixel electrodes 133 of the plurality of pixel units 130 are connected to drains of the TFTs 131 correspondingly. The common voltage generating circuit 160 provides the common electrodes 134 of the plurality of pixel units 130 with a common voltage. Sources of the TFTs 131 of each column of the plurality of pixel units 130 are connected to a corresponding data line 120. Gates of the TFTs 131 of each row of the pixel units 130 are connected to a corresponding scanning line 110.

In normal operation, the LCD panel 10 displays a frame as follows. The scanning driving circuit 140 turns on the TFTs 131 of the first row of the plurality of pixel units 130. The data driving circuit 150 provides data voltage to the pixel electrodes 133 of the capacitors 132 of the first row of the plurality of pixel units 130 correspondingly. TFTs 131 of the first row of the plurality of pixel units 130 are turned off and TFTs 131 of the second row of the plurality of pixel units 130 are turned on by the scanning driving circuit 140. The data driving circuit 150 provides the data voltage to the pixel electrodes 133 of the capacitors 132 of the second row of the plurality of pixel units 130 correspondingly. The data voltage is supplied to the other rows of the plurality of pixel units 130 in the same way. A frame can thus be displayed on the LCD panel 10.

It is known in the art that polarity of the voltage between the pixel electrode 133 and the common electrode 134 should be changed periodically to protect the LCD panel 10 from damage. A plurality of methods are used to achieve this polarity inversion, including row inversion, column inversion, frame inversion, and dot inversion. In frame inversion, undesirable flicker of the LCD panel 10 may be caused. In row and column inversion, the flicker of the LCD panel 10 is avoided, however, undesirable bright lines can occur. In dot inversion, high image quality may be obtained but considerable power consumption is required.

Referring to FIG. 6, to reduce the power consumption while maintaining image quality, a new method, referred to as 1+2 line inversion similar to dot inversion, is utilized, differing in that two adjacent pixel units 130 in the same column function as a pixel dot during polarity inversion. Power consumption, while still very high, is lower than in dot inversion.

### BRIEF DESCRIPTION OF THE DRAWINGS

FIG. 1 is a schematic view of an embodiment of an LCD panel.

FIG. 2 is a timing diagram of driving signals of the LCD panel of FIG. 1.

FIGS. 3 and 4 are schematic views of polarities of pixels of two successive frames displayed on the LCD panel of FIG. 1 when driven.

FIG. 5 is a schematic view of a commonly used LCD panel.

FIG. 6 is a schematic view of polarities of pixels of the LCD panel of FIG. 5 during 1+2 line inversion.

### DETAILED DESCRIPTION

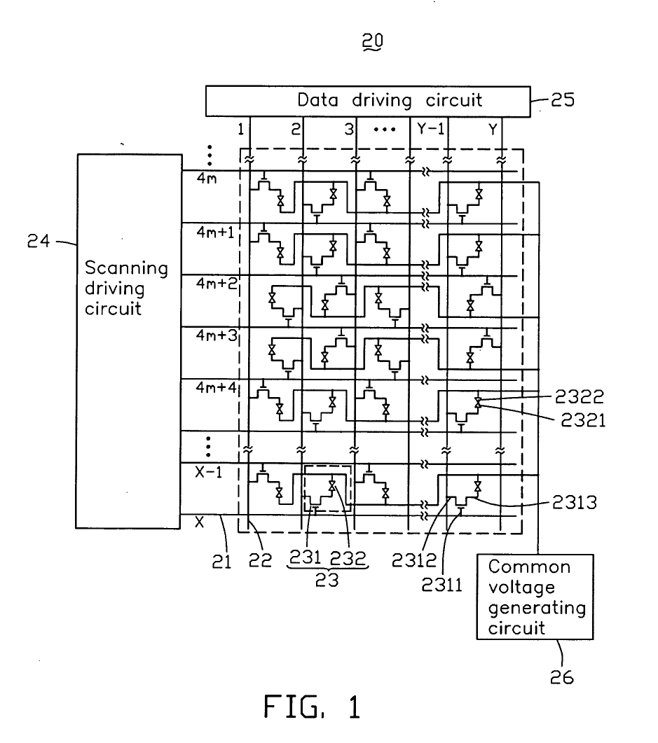

Referring to FIG. 1, an embodiment of a LCD panel 20 includes X scanning lines 21, Y data lines 22, a plurality of pixel units 23 arranged in X−1 rows and Y−1 columns, a scanning driving circuit 24, a data driving circuit 25, and a common voltage generating circuit 26. The Y data lines 22 intersect with the X scanning lines 21 vertically, and are insulated therefrom. Each of the plurality of pixel unit 23 is defined by two adjacent data lines 22 crossing two adjacent scanning lines 21.

Each of the plurality of pixel units 23 includes a TFT 231 and a capacitor 232. The TFT 231 includes a gate 2311, a source 2312, and a drain 2313. The capacitor 232 includes a pixel electrode 2321 and a common electrode 2322. The pixel electrode 2321 and the common electrode 2322 may be arranged on two opposite sides of a liquid crystal layer, not shown in this illustrated embodiment. The pixel electrode 2321 is connected to the drain 2313 of the TFT 231 in each pixel unit 23.

The X−1 rows of the plurality of pixel units 23 are numbered in sequence as 4m, 4m+1, 4m+2, X−1, and the X scanning lines 21 are numbered in sequence as 4m, 4m+1, 4m+2, . . . , X, where m is an integer equal to or greater than 0. In the number 4m row of the plurality of pixel units 23, the gates 2311 of the TFTs 231 of the pixel units 23, arranged in odd columns, are connected to the number 4m scanning line 21, and the gates 2311 of the TFTs 231 of the pixel units 23, arranged in even columns, are connected to the number 4m+1 scanning line 21.

In the number 4m+1 row of the plurality of pixel units 23, the gates 2311 of the TFTs 231 of the pixel units 23 arranged in odd columns are connected to the number 4m+1 scanning line 21, and the gates 2311 of the TFTs 231 of the pixel units 23 arranged in even columns are connected to the number 4m+2 scanning line 21.

In the number 4m+2 row of the plurality of pixel units 23, the gates 2311 of the TFTs 231 of the pixel units 23 arranged in odd columns are connected to the number 4m+3 scanning line 21, and the gates 2311 of the TFTs 231 of the pixel units 23 arranged in even columns are connected to the number 4m+2 scanning line 21.

In the number 4m+3 row of the plurality of pixel units 23, the gates 2311 of the TFTs 231 of the pixel units 23 arranged in odd columns are connected to the number 4m+4 scanning line 21, and the gates 2311 of the TFTs 231 of the pixel units 23 arranged in even columns are connected to the number 4m+3 scanning line 21.

In the number 4m+4 row of the plurality of pixel units 23, the gates 2311 of the TFTs 231 of the pixel units 23 arranged in odd columns are connected to the number 4m+4 scanning line 21, and the gates 2311 of the TFTs 231 of the pixel units 23 arranged in even columns are connected to the number 4m+5 scanning line 21.

In this embodiment, the Y−1 columns of the plurality of pixel units 23 and the Y data lines 22 are numbered by N. In the numbers 4m, 4m+1 and 4m+4 rows of the plurality of pixel units 23, the sources 2312 of the TFTs 231 of the pixel units 23 arranged in number N column are connected to the number N data line 22. In the numbers 4m+2 and 4m+3 rows of the plurality of pixel units 23, the sources 2312 of the TFTs 231 of the pixel units 23 arranged in number N column are connected to the number N+1 data line 22.

The data driving circuit 25 generates data voltage to the pixel electrodes 2321 of the capacitors 232 via the corresponding data lines 22, respectively, when the corresponding TFTs are turned on. The data voltage may be at a TTL (transistor-transistor logic) high level, such as a logical 1, or a TTL low level, such as a logical 0. The common electrodes 2322 of all of the TFTs 231 are connected to the common voltage generating circuit 26. The common voltage generating circuit 26 generates at least two different voltages. The at least two different voltages include a first voltage and a second voltage. The first voltage is equal to a maximum data voltage which is at the TTL high level, and the second voltage is equal to a minimum data voltage which is at the TTL low level. The data voltage and the common voltage are used to determine polarity of the voltage between the pixel electrode 2321 and the common electrode 2322.

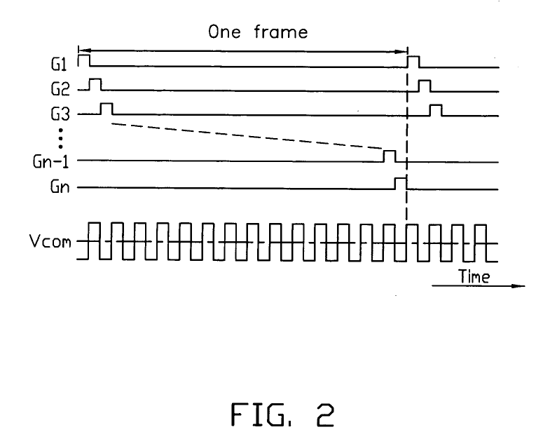

Referring to FIG. 2, a timing diagram of turning on the TFTs 231 of the X−1 rows of the plurality of pixel units 23 during display is shown. In this diagram, “G1-Gn” denote voltage levels received by the gates 2311 of the TFTs 231 of the X−1 rows of the plurality of pixel units 23 correspondingly. The voltage levels are transmitted from the scanning driving circuit 24 to the X scanning lines 21 in sequence according to the timing shown in FIG. 2. For example, when a high level voltage, such as 5V, is transmitted to the number 4m+1 scanning line 22, the other scanning lines receive low level voltages, such as 0V. The TFTs 231 connected to the number 4m+1 scanning line 22 are turned on, to transmit the data voltage to the pixel electrodes 2321 of the corresponding capacitors 232.

“Vcom” denotes the common voltages generated by the common voltage generating circuit 26. The common voltage generating circuit 26 generates the first and second voltages respectively when two adjacent scanning lines 22 receive the high level voltage one after the other. For example, when the number 4m+2 scanning line 22 receives the high level voltage, the common voltage generating circuit 26 generates one of the first and second voltages, when the number 4m+1 or 4m+3 scanning line 22 receives the high level voltage, the common voltage generating circuit 26 generates the other of the first and second voltages.

The common voltage generating circuit 26 generates the first and second voltages respectively when the same scanning lines 22 of two adjacent frames displayed by the LCD panel 10 receive the high level voltage. For example, when the number 4m+2 scanning line 22 of a first frame receives the high level voltage, the common voltage generating circuit 26 generates one of the first and second voltages, when the number 4m+2 scanning line 22 of a second frame subsequent to the first frame receives the high level voltage, the common voltage generating circuit 26 generates the other of the first and second voltages.

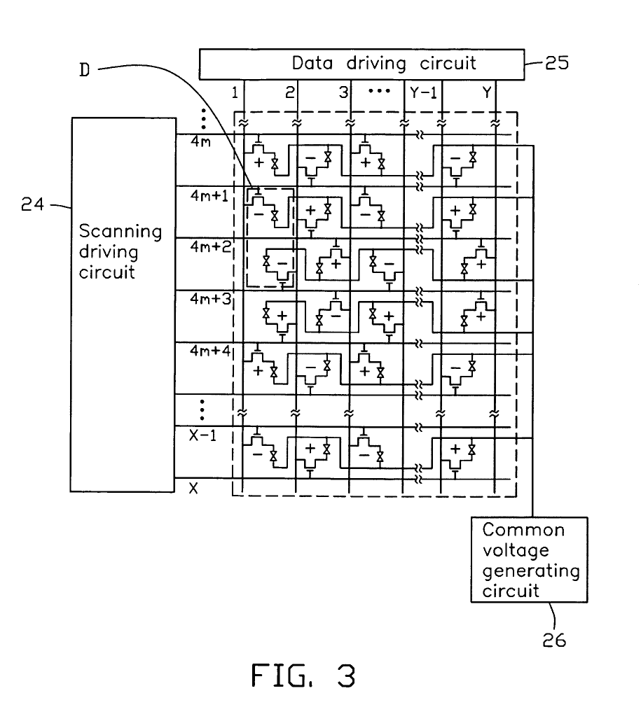

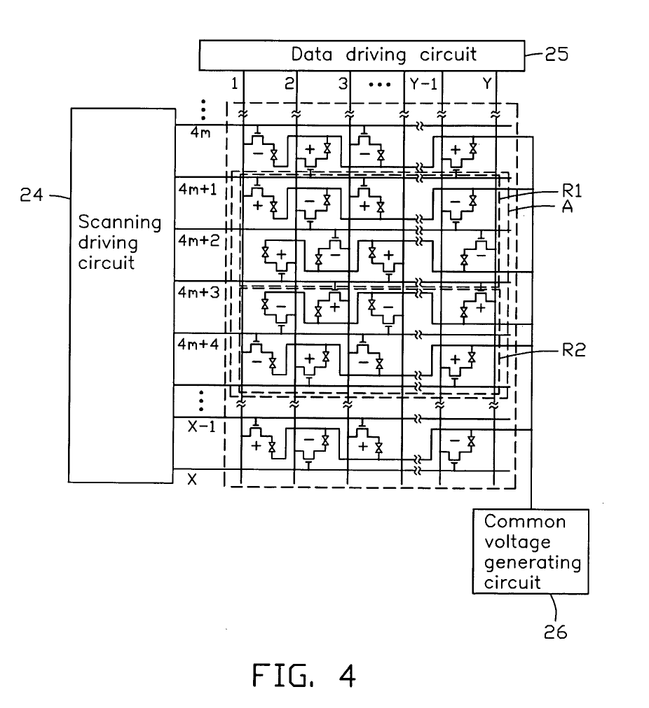

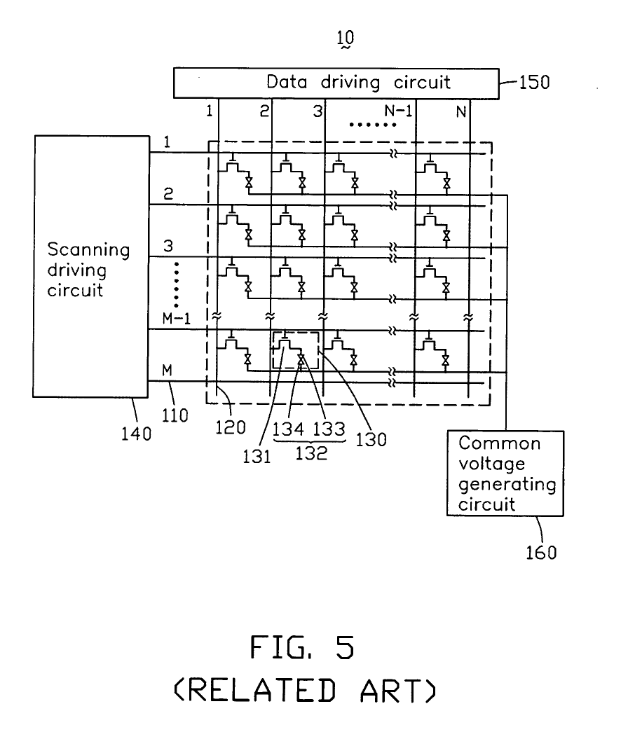

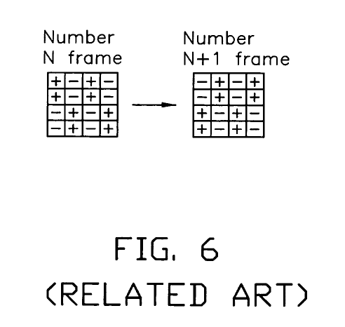

Referring to FIGS. 3 and 4, two adjacent pixel units 23 arranged in the same column form a version dot D. Every two adjacent pixel units 23 of the same frame have opposite polarities. Corresponding pixel units 23 of the two successive frames have opposite polarities. In this embodiment, the number 4m+1, 4m+2, 4m+3, and 4m+4 rows of pixel units 23 form a first display area A. The first display area A includes a first repeating area R1 and a second repeating area R2. The first repeating area R1 includes the number 4m+1, 4m+2 rows of pixel units 23 and the number 4m+1, 4m+2, 4m+3 scanning lines 22. The second repeating area R2 includes the number 4m+3, 4m+4 rows of pixel units 23 and the number 4m+3, 4m+4, scanning lines 22. The second repeating area R2 neighbors the first repeating area R1 relative to the number 4m+2 scanning line, which is a common scanning line connected to both of the first and second repeating areas R1, R2. Therefore, in this embodiment, the LCD panel 10 includes a plurality of first and second repeating areas R1, R2 arranged in alternative form. In the first repeating area R1, the gates of the pixel units 23 arranged in even columns are connected to the number 4m+2 scanning line 22, the gates of the pixel units 23 arranged in odd columns are connected to the number 4m+1 and 4m+3 scanning lines 22 respectively. In the second repeating area R2, the gates of the pixel units 23 arranged in odd columns are connected to a the number 4m+3 scanning line 22, the gates of the pixel units 23 arranged in even columns are connected to the number 4m+2 and 4m+4 scanning lines 22 respectively.

In a second embodiment, the LCD panel 10 can include only one first repeating area R1 or one second repeating area R2 while conventional structures are also used in other areas of the LCD panel 10. In a third embodiment, the LCD panel 10 may include the first display area A and a second display area in which conventional structures are used.

The LCD panel 10 may have high image quality because two adjacent pixel units 23 in the same column function as a pixel dot to perform the polarity inversion. The power consumption of the LCD panel 10 is lower than that in the 1+2 line inversion because common voltages with at least two different voltages are provided to the common electrodes 2322 of the capacitor 232.

The foregoing description of the exemplary embodiments of the disclosure has been presented only for the purposes of illustration and description and is not intended to be exhaustive or to limit the disclosure to the precise forms disclosed. Many modifications and variations are possible in light of the above everything. The embodiments were chosen and described in order to explain the principles of the disclosure and their practical application so as to enable others of ordinary skill in the art to utilize the disclosure and various embodiments and with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than the foregoing description and the exemplary embodiments described therein.

What is claimed is:

1. A liquid crystal display (LCD) panel comprising:
a repeating area, comprising a first scanning line, two second scanning lines, and a plurality of pixel units arranged in two rows and a plurality of columns, wherein the plurality of columns comprises a plurality of first columns and a plurality of second columns arranged alternately, wherein the plurality of pixel units arranged in the plurality of first columns are controlled via the first scanning line, and the two pixel units arranged in each of the plurality of second columns are controlled via the two second scanning lines, respectively.

2. The LCD panel of claim 1, wherein the first scanning line is arranged between the two second scanning lines.

3. A liquid crystal display (LCD) panel comprising:
X scanning lines; and
a plurality of pixel units arranged in X−1 rows and Y−1 columns, the X−1 rows of the plurality of pixel units and the X scanning lines arranged alternately, the X−1 rows of the plurality of pixel units comprising at least five rows of the plurality of pixel units numbered 4m, 4m+1, 4m+2, 4m+3, and 4m+4, each of X, Y and m being an integer greater than 0; wherein
in even columns of the Y−1 columns of pixel units, the pixel units arranged in the number 4m row are controlled by a number 4m+1 scanning line, the pixel units arranged in the number 4m+1 row and a number 4m+2 row are controlled by a number 4m+2 scanning lines, and the pixel units arranged in the number 4m+3 row are controlled by a number 4m+3 scanning line;
in odd columns of the Y−1 columns of pixel units, the pixel units arranged in the number 4m+1 row are controlled by the number 4m+1 scanning line, the pixel units arranged in the number 4m+2 row are controlled by the number 4m+3 scanning line, and the pixel units arranged in the number 4m+3 row and the number 4m+4 row are controlled by a number 4m+4 scanning line.

4. The LCD panel of claim 3, further comprising Y data lines intersecting the X scanning lines vertically, and insulated from the X scanning lines, wherein each of the plurality of pixel units is defined by two adjacent data lines crossing two adjacent scanning lines, two pixel units which are controlled by the same scanning line receive data voltage from two of the Y data lines respectively.

5. The LCD panel of claim 4, wherein each of the plurality of pixel units comprises a thin film transistor (TFT) and a pixel electrode, the TFT comprises a gate connected to a corresponding X scanning line, a source connected to the corresponding Y data scanning line, and a drain connected to the pixel electrode, the TFT is turned on in response to receiving a high level voltage via the corresponding X scanning line, and the pixel electrode receives a data voltage from the corresponding Y data line via the TFT, wherein each of the plurality of pixel units is controlled via the corresponding TFT.

6. The LCD panel of claim 5, wherein each of the plurality of pixel units further comprises a common electrode, the common electrode receiving first and second common voltages from a common voltage generating circuit.

7. The LCD panel of claim 5, further comprising a scanning driving circuit generating the high level voltage to the corresponding X scanning line, and a data driving circuit providing the data voltage to the corresponding Y data line.

8. A liquid crystal display (LCD) panel comprising:
a first repeating area comprising a first scanning line, a second scanning line, a third scanning line, and two rows of first pixel units arranged in matrix; and
a second repeating area neighboring the first repeating area relative to the third scanning line, the second repeating area comprising a fourth scanning line, a fifth scanning line, and two rows of second pixel units arranged in matrix;
wherein the first pixel units arranged in even columns in the matrix are controlled by the second scanning line, the two first pixel units arranged in each odd column in the matrix are controlled by the first and third scanning lines respectively; wherein the second pixel units arranged in odd columns are controlled by the fourth scanning line and the two second pixel units arranged in each even column are controlled by the third and fifth scanning lines respectively

9. The LCD panel of claim 8, wherein the second scanning line is arranged between the first and third scanning lines, and the fourth scanning line is arranged between the third and fifth scanning lines.
